(19) United States
(12) Patent Application Publication
(10) Pub. No.: US 2016/0153487 A1
(43) Pub. Date: Jun. 2, 2016

(54) Fastener with improved gate

(71) Applicant: Steven J. Hollinger, Boston, MA (US)

(72) Inventor: Steven J. Hollinger, Boston, MA (US)

(21) Appl. No.: 14/556,073

(22) Filed: Nov. 28, 2014

(51) Int. Cl. F16B 45/02; F16B 45/04

(52) U.S. Cl. CPC F16B 45/02; F16B 45/04

(57) ABSTRACT

Fasteners with a body, a hook and a gate, the gate biased to a closed position and capable of being conveniently manipulated to an open position by swinging inward toward the body or outward away from the body. Also disclosed is a lock to prevent inadvertent opening of the gate.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention has generally to do with fasteners.

2. Description of Related Art

Hooks, clips and other fasteners are known in prior art. Fasteners with gates such as carabiners, spring clips, swivel clips and other clips such as the breech clip exampled at 100 in FIG. 1 are known in prior art. Double carabiners such as exampled at 110 in FIG. 1 are known in prior art.

In the sport of rock climbing, carabiners are used for securing a belay device to the harness of the climber. Carabiners can also be used to securely hang an object from a loop, such as a key ring hanging from a belt loop.

Prior art carabiners have a main body and a gate such which cooperate to form an enclosure used for a variety of purposes as described above. Gates of prior art carabiners are biased towards a closed position. When the climber desires to place a rope, loop, clip or other piece of equipment within the enclosure of a carabiner, the gate may be pivoted inwardly, allowing access to the enclosure. The gate will pivot to a closed position under the influence of a biasing spring.

Prior art double carabiner 110 has main body 111, hook 116 and gate 112 which cooperate to form an enclosure. Spring 113 biases gate 112 towards tip 115 of hook 116. Tip 115 restricts gate 112 from swinging outwardly away from main body M.

Often the carabiner will be used when the climber is on the face of the rock. One problem with prior art carabiners is that they must be properly oriented with respect to the piece of equipment to which they will be attached or removed. The carabiner must be oriented so that the gate faces the piece of equipment. This can be awkward and disadvantageous if the climber is in a position which makes it difficult to so position the carabiner. If nothing else, it requires the climber to be concerned about one additional factor while on the face of the rock.

Another disadvantage of the prior art carabiner is that the gate must be manipulated to allow for removal of the carabiner. This often requires direct contact with the gate and, particularly with smaller carabiners, requires nimble positioning of the fingers to swing the gate inward.

Another disadvantage of prior art carabiners is that a cord or piece of equipment, if securely enclosed within the area formed by the main body and the gate, may obstruct the gate from being manually moved inward. Detachment of a carabiner often requires a deliberate repositioning of the equipment secured within the enclosure in order to allow the gate to swing inward.

Prior art fasteners are not capable of meeting a number of challenges. In the sport of stand-up paddle boarding, a leash from the paddler's ankle must be attached to the paddleboard deck to prevent accidental loss of the board. The paddleboard has a recessed well, known as a leash plug or leash cup. The leash cup has an eyelet, most often in the form of a small metal bar, within the recessed well, provided as a secure point of attachment for the paddler's leash. The eyelet is recessed within the well to ensure that the paddleboard does not have protruding components that could injure the paddler's feet. Prior art fasteners having a hook and inward-swinging gate, such as a prior art carabiner, are difficult to insert into the recessed cup and engage with the eyelet within the cup while at the same time providing enough clearance for the gate to return to a closed position over the top of the eyelet. For this reason, paddlers typically run a slipknot or a cord through the recessed eyelet in the leash cup rather than attempting to secure a clip or other piece of rigid hardware to the eyelet within the recessed cup.

Therefore, there exists a need for a fastener that lows for its attachment irrespective of its orientation to the desired surface of attachment. The need also exists for a fastener that does not require its user to have direct, manual contact with the gate in order to release equipment from its enclosure. The need also exists for a fastener with a gate that will not be obstructed or otherwise restricted from normal operation by a cord or other piece of equipment that is being held within the enclosure of the fastener. The need also exists for a fastener that can be attached and detached to an eyelet in a recessed area such as the eyelet formed within a stand-up paddleboard leash cup, where clearance for manual access to the gate is limited. The need also exists for a fastener that can be attached to an eyelet such as the eyelet formed within a stand-up paddle board leash cup, an eyelet that does not have adequate clearance for the tip of hook to fit underneath while still allowing unrestricted motion of an inwardly-sweeping gate.

The fastener of this invention addresses these problems and other disadvantages of prior art fasteners.

### BRIEF SUMMARY OF THE INVENTION

A fastener for attaching items includes a body, and a hook having a proximal end oriented on the body and a tip oriented away from the body to form an opening. The fastener further includes a gate having a proximal end attached to the body and a distal end away from the body. The fastener further includes means for biasing the gate such that the distal end of the gate is proximate to the tip of the hook without making contact with the tip of the hook. The gate is configured to prevent contact with the hook. In one such configuration, the distance from the proximal end of the gate to the distal end of the gate is less than the distance from the proximal end of the gate to the tip of the hook.

In another embodiment, a double carabiner includes a body, the body having a first hook and a second hook, the first and second hooks having a first opening and a second opening, respectively.

The double carabiner further includes a first gate and a second gate, the first and second gates interconnected with the body, such that the first gate substantially closes the first opening to form a first enclosure and the second gate closes the second opening to form a second enclosure. The first gate has a proximal end attached to the body and a distal end away from the body, the first gate biased such that the distal end of the first gate is proximate to the tip of the hook without making contact with the tip of the first hook. The first gate is configured to prevent contact with the first hook.

In another embodiment, a double carabiner includes a body, the body having a first hook and a second hook, the first and second hooks having a first opening and a second opening, respectively. The double carabiner further includes a first gate and a second gate, the first and second gates interconnected with the body, such that the first gate substantially closes the first opening to form a first enclosure and the second gate closes the second opening to form a second enclosure. In this embodiment, the first gate has a proximal end attached to the body and a distal end away from the body, the first gate biased such that the distal end of the first gate is proximate to the tip of the hook without making contact with the tip of the first hook. In this embodiment, the second gate has a proximal end attached to the body and a distal end away from the body, the second gate biased such that the distal end is proximate to the tip of the second hook without making contact with the tip of the second hook. The first gate is configured to prevent contact with the first hook and the second gate is configured to prevent contact with the second hook.

In another embodiment, a locking fastener for attaching items includes a body, and a hook having a proximal end attached to the body and a tip away from the body to form an opening. The locking fastener further includes a gate having a proximal end attached to the body and a distal end away from the body, the gate biased such that the distal end of the gate is proximate to the tip of the hook without making contact with the tip of the hook. The gate is configured to prevent contact with the hook. The locking fastener further includes a sliding lock, the sliding lock configured to slide up and down the gate. In this embodiment the sliding lock has a first position, the first position being a locked position where the sliding lock is positioned to engage the tip of the hook, and a second position, the second position being an unlocked position where the sliding lock is away from the distal end of the gate such that the sliding lock does not engage the tip of the hook.

In another embodiment, a locking fastener for attaching items includes a body, and a hook having a proximal end attached to the body and a tip away from the body to form an opening. The locking fastener further includes a gate having a proximal end attached to the body and a distal end away from the body, the gate biased such that the distal end of the gate is proximate to the tip of the hook without making contact with the tip of the hook. The gate is configured to prevent contact with the hook. The locking fastener further includes a sliding lock, the sliding lock configured to slide on the hook. In this embodiment the sliding lock has a first position, the first position being a locked position where the sliding lock is positioned at the tip of the hook to engage the distal end of the gate, and a second position, the second position being an unlocked position where the sliding lock is away from the tip of the hook such that the sliding lock does not engage the distal end of the gate.

### BRIEF DESCRIPTION OF THE SEVERAL VIEWS OF THE DRAWINGS

FIG. 1 shows fasteners of prior art; and

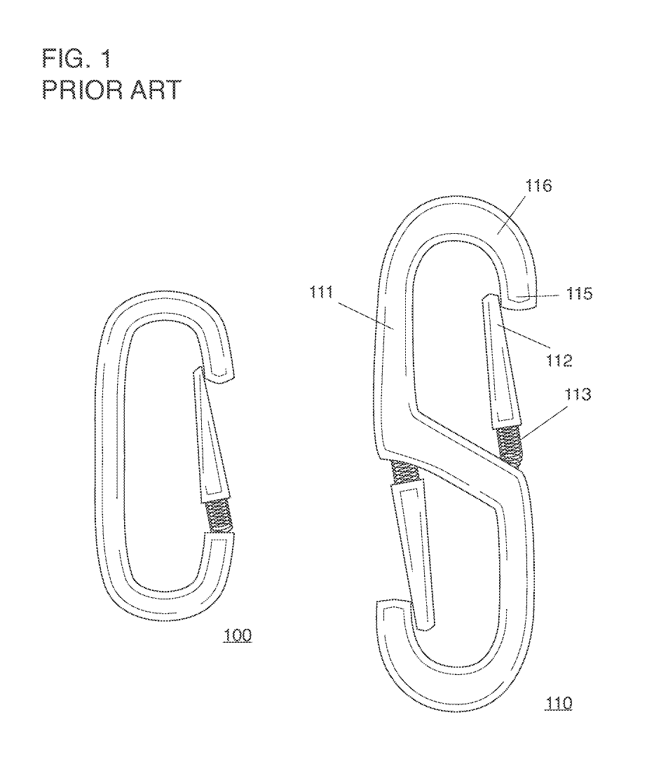

FIG. 2 shows the preferred embodiment of the fastener of this invention; and

FIG. 3 shows the preferred embodiment in operation to illustrate how the fastener is capable of opening inwardly and outwardly with respect to the body; and

FIG. 4 shows other embodiments of the fastener of this invention; and

FIG. 5 illustrates one embodiment of a locking fastener with a slide on the gate, shown in an open and closed position; and

FIG. 6 illustrates another embodiment of a locking fastener with a slide on the hook shown in an open and closed position.

### DETAILED DESCRIPTION OF THE INVENTION

Fasteners used in a variety of applications must withstand significant force applied end-to-end. An example of such a fastener is a carabiner used for rock climbing. The weight of a rock climber may be expressed as a force acting to pull the ends of the carabiner apart from one another. The carabiner is designed to withstand this force. A carabiner is not designed to withstand the same force acting on its gate, pressing the gate inwardly or outwardly.

Forces expressed on the gate of a carabiner, pressing the gate inwardly, are typically limited to the pressure applied by the rock climber attempting to manually open the gate. Forces acting against the gate of a carabiner, pushing the gate outwardly, are usually limited to those required to restrain cords or piece of equipment within the carabiner's enclosure predominately when the cords or pieces of equipment are not in tension with one another. Another force typically acting against the gate of a carabiner, pushing the gate outwardly, is expressed by a spring pressing the gate against an opposing hook to maintain a closed position.

An improved fastener is described by the fastener of this invention, one with a gate suited to withstand only those forces that are predominately expected to act upon a gate, such as those expressed by cords, eyelets and gear requiring nominal restraint from falling out of the enclosure. Such an improved fastener need not sacrifice strength in managing end-to-end tension expected of fasteners such as carabiners.

The fastener of this invention improves ease of use in applications where substantial force may be expected to act on the fastener from end-to-end, but only nominal forces are expected to be expressed on the gate of the fastener, acting to push the gate inward or outward. Unlike a fastener without a gate, the fastener of this invention provides a gate that is fully capable of preventing the inadvertent loss of a cord or a piece of equipment.

The fastener of this invention has a gate that is capable of opening inwardly as well as outwardly, away from the enclosure. This improvement allows the user to quickly and easily release the fastener without manually pulling a gate inward, as is required of carabiners. The user of the fastener of this invention can grasp the fastener body, without direct contact to the gate, and pull away from the gear to be released. Another advantage of this fastener is that it can be clipped and unclipped in areas where the gate is not manually accessible to the user.

A fastener with a gate that is capable of swinging inwardly, outwardly and in other directions relative to its body improves ease of clipping the fastener to awkwardly positioned eyelets and other points of attachment. One such point of attachment is the eyelet recessed within the leash cup of a stand-up paddleboard. Another such point of attachment may be an eyelet that would otherwise be difficult to align with an inwardly swinging gate.

A fastener with a gate that is capable of swinging outwardly makes possible the clipping of the fastener of this invention to an eyelet or piece of equipment too large to provide enough clearance for the same gate to swing inward. This advantage allows for the manufacture of a gated fastener having a hook with an extremely short tip, smaller in length than the diameter of the cord or piece of equipment enclosed by and restrained within the fastener.

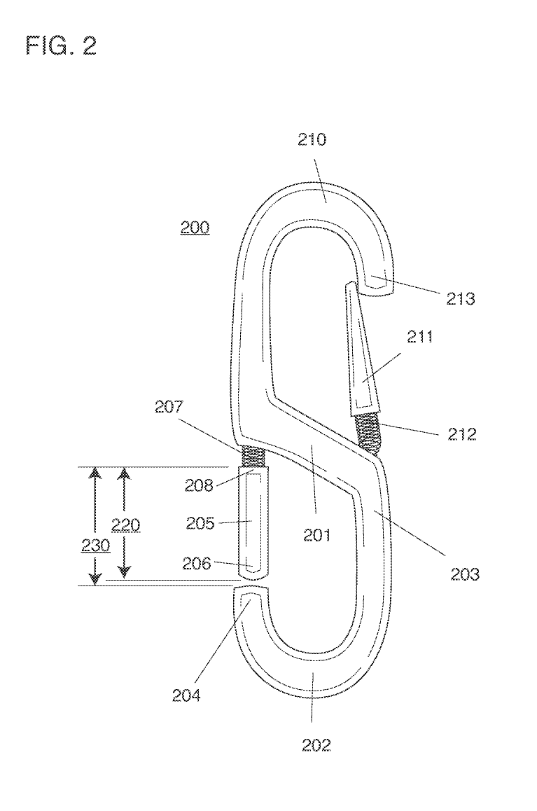

The preferred embodiment of the fastener of this invention is double carabiner 200 shown in FIG. 2. Double carabiner 200 has body 201, and hook 202. Hook 202 has proximal end 203 on body 201 and tip 204 away from body 201 to form an opening. Carabiner 200 further includes gate 205 having proximal end 208 and distal end 206. Gate 205 is biased by spring 207 such that distal end 206 is proximate to tip 204 without making contact with tip 204. The gate is configured to prevent contact with the hook. In the preferred embodiment gate 205 is configured so that distance 220, measured from proximal end 208 to distal end 206, is less than distance 230, measured from proximal end 208 to the nearest point of distal tip 204, so that gate 205 is prevented from contacting tip 204. Double carabiner 200 further comprises a clip formed by hook 210, gate 211 and spring 212. Gate 211 is biased by spring 212 to maintain a closed position against tip 213 of hook 210.

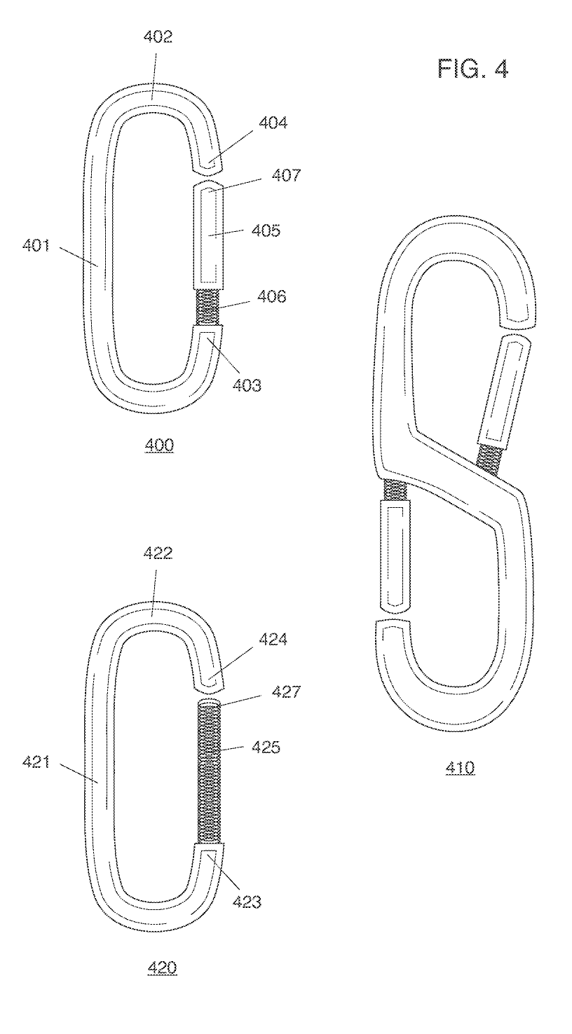

It is anticipated that the fastener of this invention may have a gate and spring, such as exampled by gate 205 and spring 207 of FIG. 2, manufactured of a single material in a unified construction. Such a gate may be formed as a wireframe manufactured using spring wire. An example of a fastener with a unified gate and spring is shown at 420 in FIG. 4.

It is anticipated that means to bias the gate, so that the distal end of the gate is proximate to the of the hook, may be a spring as exampled in FIG. 2 or other means such as a magnet.

It is anticipated that the fastener of this invention has a gate configured to prevent contact between the end of the gate and the tip of the hook. Such a configuration may be possible using a gate of insufficient length to span the opening between the body and the tip of the hook, falling short of the tip and thereby rendered incapable of contact with the tip. Other configurations of a gate may be possible that allow the gate to extend past the tip of the hook while avoiding capture by or contact with the tip of the hook.

In the preferred embodiment as exampled in FIG. 2, spring 207 is shown between body 201 and gate 205. As represented by this illustration, it is anticipated that means for biasing the gate of the fastener of this invention may be between the gate and the body. Alternatively, it is anticipated that the gate may be attached directly to the body; and the means for biasing the gate affixed to the body and in contact with the gate in order to bias the gate. Alternatively, it is anticipated that the gate may be affixed directly to the body; and the means for biasing the gate affixed to the gate and in contact with the body in order to bias the gate. Lastly, as another alternative, it is anticipated that the gate may be affixed directly to the body; and the means for biasing the gate affixed to both the gate and the body.

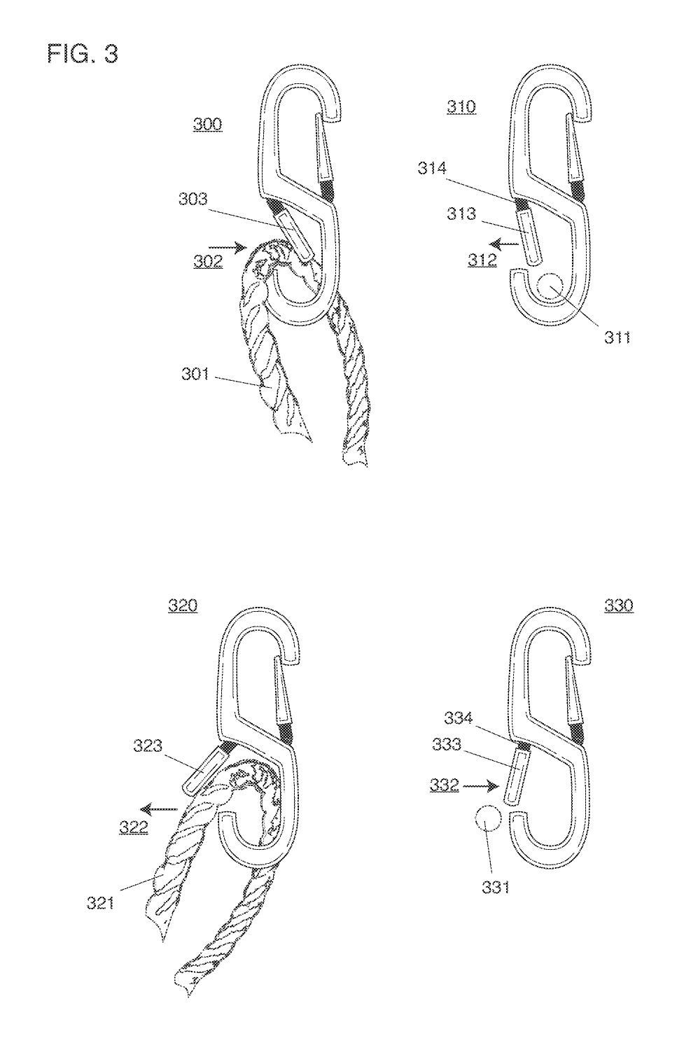

Operation of the preferred embodiment of this invention is shown in four stages at 300, 310, 320 and 330 in FIG. 3. In a first illustration at 300, a cord is brought into contact with the gate, entering the enclosed area of the fastener. In a successive illustration at 310, the cord clears the gate and the gate returns to a dosed position. In a successive illustration at 320, the cord is brought into contact with the gate as it is removed from the enclosure. In a final illustration at 330, the cord clears the gate after being removed from the enclosure and the gate returns to a closed position.

Cord 301 is represented by cord 321 in the illustration at 320, and by cross section 311 in the illustration at 310, and by cross section 331 in the illustration at 330. This cord is representative of a rope, an eyelet or any piece of equipment that may be anticipated to engage h the fastener of this invention.

As shown at 300, when cord 301 is manipulated by user of h fastener in direction 302, as the user presses the cord against gate 303, gate 303 swing How cord 301 to enter the closure.

As shown at 310, upon cord 311 being moved into the enclosure and clearing gate 313, spring 314 biases gate 313 in direction 312, returning gate 313 to a closed position as represented in FIG. 2. When gate 313 is closed, cord 311 is restrained by gate 313 from falling or bouncing out of the enclosure.

As shown at 320, when the user of the fastener presses cord 321 in direction 322 against gate 323, gate 323 swings outward to allow cord 321 to be removed from the enclosure.

As shown at 330, upon cord 331 fully exiting the enclosure and clearing gate 333, spring 334 biases gate 333 in direction 332, returning gate 333 to a closed position as represented in FIG. 2.

Other embodiments of the fastener of this invention are illustrated in FIG. 4.

In one embodiment, 0-shaped fastener 400 of FIG. 4 includes body 401, and hook 402 having and distal tip 404 away from body 401 to form an opening. Fastener 400 further includes gate 405 on distal end 403 of body 401, biased by spring 406 such that distal end 407 of gate 405 is proximate to distal tip 404 of hook 402 without making contact with distal tip 404.

In another embodiment, O-shaped fastener 420 of FIG. 4 has a unified gate and spring, hereafter referred to as spring-gate. As shown, fastener 420 has body 421, and hook 422 having and distal tip 424 away from body 421 to form an opening. Fastener 420 further includes spring-gate 425 on distal end 423 of body 421. Spring-gate 425 is oriented so that distal end 427 of spring-gate 425 is proximate to distal tip 424 of hook 422 without making contact with distal tip 424.

In another embodiment, double carabiner 410 has two enclosures formed by two gates and two respective hooks, each gate proximate to but not making contact with each respective hook, thus each gate performing as described of gate 205 in FIG. 2.

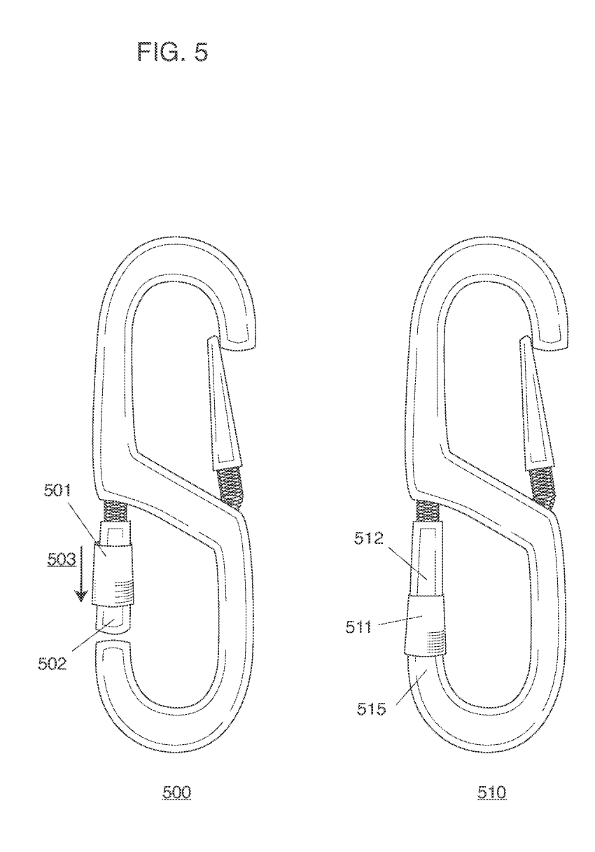

In another embodiment, the fastener of this invention comprises a sliding lock to restrict the gate from being inadvertently swung into an open position. FIG. 5 shows an example fastener of this embodiment, with a sliding lock shown in an open position at 500 and a closed, locked position at 510. The sliding lock shown at 501 and 511 in FIG. 5 is a conical tube mounted on a gate of widening dimensions, the widened portion of the gate preventing the lock from sliding completely off its gate.

As shown at 500, when sliding lock 501 is positioned on gate 502 away from the tip of the gate, gate 502 can be manipulated to swing inward or outward as described by the double carabiner exampled in FIG. 3. To lock gate 502, sliding lock 501 can be manipulated by the user of the fastener to slide along gate 502 in direction 503.

As shown at 510, when sliding lock 511 encloses both tip of hook 515 and tip of gate 512, gate 512 is prevented from swinging inward or outward.

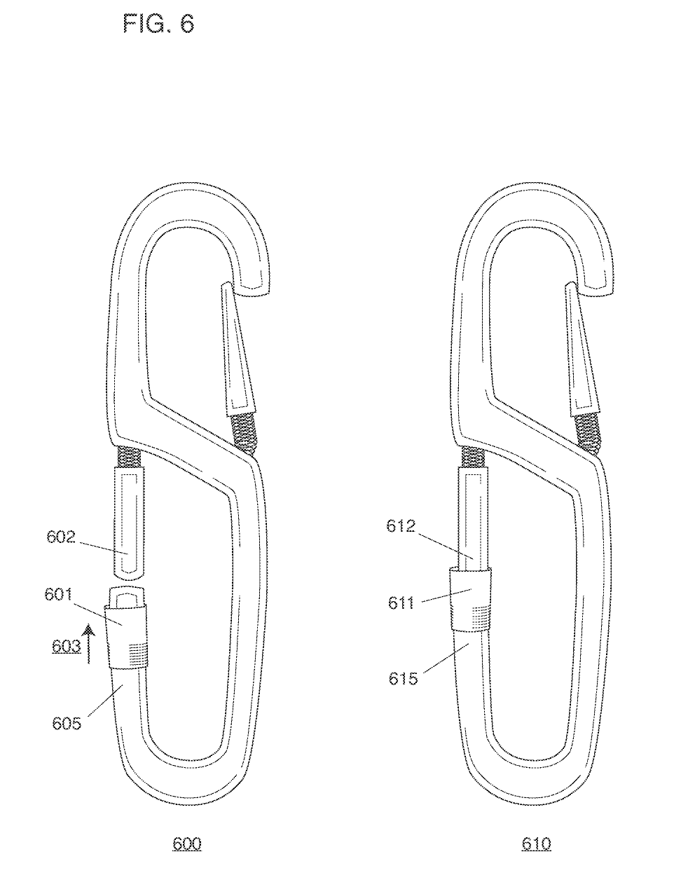

FIG. 6 shows another example embodiment of a fastener with a sliding lock. in this example, a sliding lock is shown in an open position at 600 and a closed, locked position at 610. The sliding lock shown at 601 and 611 in FIG. 6 is a conical tube mounted on a hook of dimensions widening at its tip, the widened portion of the hook preventing the lock from sliding completely off the end of the hook.

As shown at 600, when sliding lock 601 is manipulated by the user to a position along hook 605 away from the tip of the hook, gate 602 can be manipulated to swing inward or outward as described in the double carabiner illustrated in FIG. 3. To lock gate 602, sliding lock 601 can be manipulated to slide along hook 605 in direction 603.

As shown at 610, when sliding lock 611 encloses both tip of hook 615 and tip of gate 612, gate 612 is prevented from swinging inward or outward.

### CONCLUSION

The foregoing Detailed description has disclosed to those skilled in the relevant disciplines how to make and use the fastener of the invention and has also disclosed the best mode presently known to the inventor of making and using such fastener. It will however be immediately apparent to those skilled in the relevant disciplines that fasteners made according to the principles of the invention may be implemented in many ways other than the ways disclosed herein. For example, although D-shaped and S-shaped examples of fasteners are described, aspects of embodiments of the invention described herein may be applicable to other fastener shapes. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A fastener comprising:
a body;
a first hook oriented on the body having a first distal tip away from the body;
a first gate having a first proximal end attached to the body and a first distal end away from the body; and
means for biasing the first gate so that the first distal end is proximate to the first distal tip to form an enclosure; wherein
the first gate is configured to prevent contact between the first distal end and the first distal tip.

2. The fastener of claim 1 wherein:
the means for biasing the gate is a spring.

3. The fastener of claim 2 wherein:
the spring and the gate are a unified construction.

4. The fastener of claim 1 further comprising:
a second hook oriented on the body having a second distal tip away from the body;
a second gate having a second proximal end attached to the body and a second distal end away from the body; and
means for biasing the second gate so the second distal end is proximate to the second distal tip to form an enclosure.

5. The fastener of claim 4 wherein the second gate is configured to prevent contact between the second distal end and the second distal tip.

6. The fastener of claim 4 wherein:
the means for biasing the first gate is a first spring and the means for biasing the second gate is a second spring.

7. The fastener of claim 6 wherein:
the first spring and the first gate are a unified construction; and
the second spring and the second gate are a unified construction.

8. The fastener of claim 1 further comprising means for locking the first gate in a closed position.

9. The fastener of claim 8 wherein the means for locking the first gate is a first slide configured to slide up and down the gate, the first slide having a first position and a second position in relation to the fastener, the first position locking the first gate and the second position unlocking the first gate.

10. The fastener of claim 9 wherein the first slide in the first position retains the first distal end in a position proximate to the first distal tip.
